(19) United States
(12) Patent Application Publication
(10) Pub. No.: US 2009/0193718 A1
(43) Pub. Date: Aug. 6, 2009

(54) Snap-in Lifter Plate

(76) Inventors: Spiridon-Sorin S. Tudora, Richmond Hill (CA); Hung Chi Yong, Mississauga (CA); Gabriele Wayne Sabatini, Keswick (CA); Miroslav Janda, Toronto (CA)

Correspondence Address: MAGNA INTERNATIONAL, INC., 337 MAGNA DRIVE, AURORA, ON, L4G-7K1, CA

(21) Appl. No.: 12/303,382

(22) PCT Filed: Jun. 6, 2007
(86) PCT No.: PCT/CA2007/001000

§ 371 Date: Dec. 4, 2008

Related U.S. Application Data
(60) Provisional application No. 60/811,272, filed on Jun. 6, 2006.

(51) Int. Cl. E05F 11/38

(52) U.S. Cl. 49/358

(57) ABSTRACT

The invention is a lifter plate for a window regulator adapted for the insertion of a window glass. The lift plate includes a main body portion adapted for translational movement by the window regulator. A flange jaw is spaced apart from the main body portion and connected to the main body portion by a flexible joint interconnecting the body portion and the flange jaw. The flexible joint is integrally formed as part of the lifter plate and is shaped in an undulating waveform pattern.

### FIELD OF THE INVENTION

The present invention relates to automotive window regulators. More specifically, the present invention relates to an improved snap-in lifter plate

### BACKGROUND OF THE INVENTION

Motor vehicles side doors are typically equipped with a window regulator in order to raise or lower the side door window glass. The window glass must be securely mounted to the lifter plate on the window regulator in order to withstand the rigors of daily use. In addition, the window glass should be easy to mount to the lifter plate, requiring a minimal amount of labor and parts to install. Also preferably, the window glass should be convenient to remove from the window regulator should it need replacing. Thus, snap-in window plates have become a popular and economic method of window glass retention.

Snap-in lifter plates typically consist of a main body portion that can be attached to a cable and/or mounted to a rail, a flange jaw spaced apart from the main body portion to provide a channel for the window glass, a flange hook extending from the flange jaw and adapted to catch an aperture in the window glass, and a hinge that interconnects the body and the flange jaw. When the glass is partially inserted, the flange jaw is pivoted out of the way along the hinge. When the window glass is fully inserted, the flange jaw pivots back into place and the flange hook extends through an aperture in the window glass for a positive snap. Current industry standards typically require that the window glass be able to withstand a force of greater than 667 N in the vertical plane at all ambient temperatures. In addition, the window glass should be easy to mount to the lifter plate, requiring no more than 67 N of force in the vertical plane at all ambient temperatures. The problem is that decreasing the thickness of the joint at the base of the flange, while decreasing the force required for glass insertion also decreases the vertical retention strength of the window glass as well.

Another problem that occurs in prior art snap-in lifter plates is that the flange jaw around the flange hook needs to be structurally reinforced due to the need for a “windowed” cut-out region beneath the flange hook in order to manufacture the hook using conventional molding techniques.

What is desired is a snap-in lifter plate which meets or exceeds the requirements for structural strength while still providing for easy insertion of the window glass. It is also desired to provide a snap-in lifter plate that is easy and economical to manufacture.

### SUMMARY OF THE INVENTION

It is an object of the invention to provide a snap-in lifter plate that meets or exceeds the requirements for structural strength while still providing for easy insertion of the window glass. According to a first aspect of the invention, there is provided a lifter plate for a window regulator adapted for the insertion of a window glass. The lift plate includes a main body portion adapted for translational movement by the window regulator. A flange jaw is provided, spaced apart from the main body portion. A flexible joint, integrally formed as part of the lifter plate, interconnects the body portion and the flange jaw.

### BRIEF DESCRIPTION OF THE DRAWINGS

Preferred embodiments of the present invention will now be described, by way of example only, with reference to the attached Figures, wherein:

FIG. 1 shows an isometric view of a window regulator including a pair of snap-in lifter plates, in accordance with an embodiment of the invention;

FIG. 2 shows a front plan view of one of the snap-in lifter plates shown in FIG. 1; and

FIG. 3 shows a side plan view of the snap-in lifter plate shown in FIG. 2.

### DETAILED DESCRIPTION OF THE INVENTION

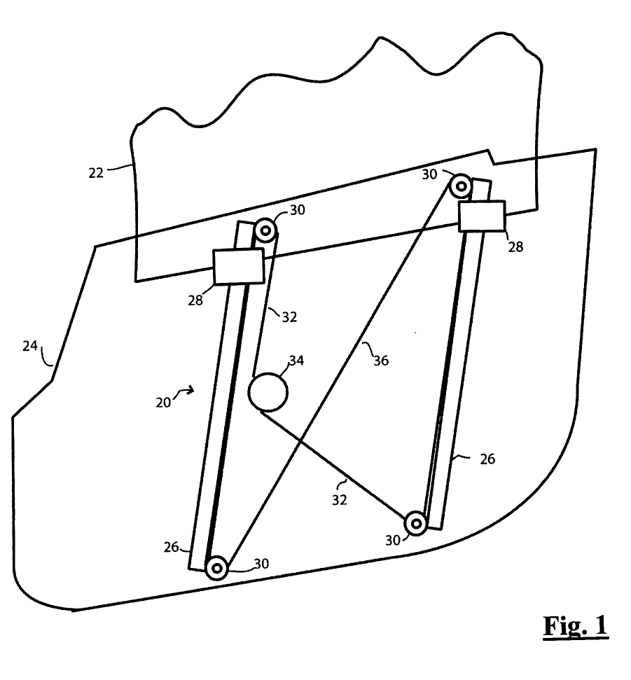

Referring now to FIG. 1, a window regulator 20 operable to transport a window glass 22 or other closure panel between an open position (i.e., the door window is open) and a closed position (i.e., the door window is closed) is shown. FIG. 1 shows window glass 22 located approximately in its closed position. Window regulator 20 is incorporated onto a carrier panel 24. Carrier panel 24 is affixed to a vehicle door frame (not shown). As is well known in the art, carrier panel 24 acts as an equipment module, carrying a variety of the door components and may be a sealed hardware carrier, non-sealed hardware carrier, trim panel, etc.

Window regulator 20 includes a pair of parallel rails 26, aligned in the direction of glass travel. A lifter plate 28 is slidably mounted along an edge of each rail 26, and is described in greater detail below. Pulleys 30 are rotatably mounted adjacent the ends of the two rails 26. Those skilled in the art will understand that pulleys 30 could be replaced by arcuate non-rotating sliding surfaces. A pair of cables 32 is attached at one end to each of the two lifter plates 28 and routed around a pair of pulleys 30. The other end of cables 32 is attached to a cable drum 34. A reversible motor (not shown) is operably attached to cable drum 34 in order to drive it, thereby raising or lowering lift plates 28. Alternatively, cable drum 34 could be attached to the output of a hand crank (also not shown). A follower cable 36 is attached to the two lifter plates 28 and routed around the other two pulleys 30. The configuration of window regulator 20 is not particularly limited and other configurations and arrangements of rails, pulleys and the like can be made without departing from the scope of the invention.

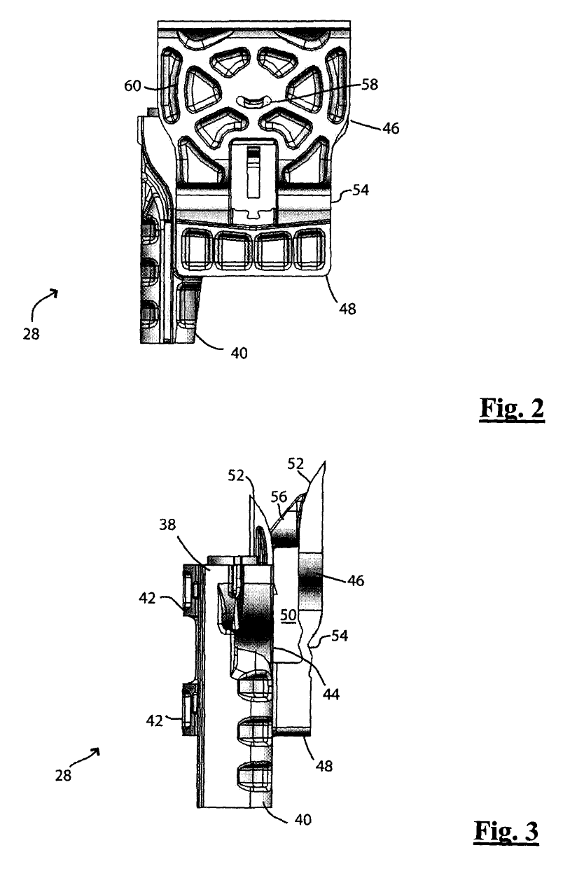

Referring now to FIGS. 2 and 3, lifter plates 28 are described in greater detail. Preferably, lifter plates 28 are molded from a high impact plastic, and each lifter plate 28 includes a body 38 having an integrally-formed cable housing 40 operable to retain the ends of cables 32. Each body 38 further includes an integral rail mount 42, complementarily shaped as to allow the lifter plate to be retained along rail 26 and move along the rail in a sliding action. Along body 38, on the side opposite rail mount 42 is a wall surface 44. A flange jaw 46 is spaced apart from wall surface 44 via a base portion 48 forming a channel 50 therebetween. When window glass 22 (not shown) is located within channel 50, flange jaw 46 and wall surface 44 are generally parallel. Sloped portions 52 are provided at the ends of wall surface 44 and flange jaw 46 to assist in located the window glass into channel 50 during glass insertion. Flange jaw 46 is joined to base portion 48 via an integral hinge 54. Integral hinge 54 is formed in an undulating waveform shape that is thinner than the adjacent flange jaw 46 or base portion 48. Acting as two springs in parallel, the waveform pattern increases the length of the bending surface when flange jaw 46 is pivoted away from wall surface 44 so that the majority of flexing stress is isolated to integral hinge 54. Thus, integral hinge 54 allows for a thicker cross section (thus increasing structural strength) without excessive hindrance of glass insertion efforts.

A flange hook 56 is provided on flange jaw 46 that extends across channel 50 and abuts against wall surface 44. When the window glass 22 is inserted into lifter plate 28, the leading edge of the window glass abuts against a ramp surface 58 on flange hook 56 pivoting flange jaw 46 along integral hinge 54 away from wall surface 44. Once the window glass is completely inserted into channel 50 (i.e., the leading edge of window glass rests against base portion 48), an aperture in the window glass (not shown) is aligned with flange hook 56 allowing flange jaw 46 to pivot back into parallel alignment with wall portion 46, and providing a positive snap-in lock. Flange jaw 46 and wall surface 44 abut against the window glass in a tight frictional fit and flange hook 56 now extends through the window glass aperture to retain the window glass in place. A window 58 is provided in flange jaw 46 to assist in the forming of flange jaw 46 during the molding process. Structural reinforcement ridges 60 are provided along the surface of flange jaw 46 and are arranged in a radial web-shaped pattern to improves the rigidity of the sidewall under a glass pull-out loading scenario.

What is claimed is:

1. A lifter plate for a window regulator adapted for the insertion of a window glass, the lift plate comprising:
a main body portion adapted for translational movement by the window regulator;
a flange jaw spaced apart from the main body portion and connected to the main body portion by a flexible joint interconnecting the body portion and the flange jaw, and wherein the flexible joint is integrally formed as part of the lifter plate.

2. The lifter plate of claim 1, wherein the flexible joint is operable to pivot the flange jaw away from the main body portion during insertion of the window glass.

3. The lifter plate of claim 1, wherein the flexible joint is formed in an undulating wave form configuration.

4. The lifter plate of claim 3, wherein the flange jaw includes a flange hook extending towards the main body portion the flange hook operable to engage a mounting aperture in the window glass.

5. The lifter plate of claim 4, wherein the flange jaw includes a plurality of ridges arranged in a web-shaped pattern extending radially from the base of the flange hook.
